(19) United States
(12) Patent Application Publication
(10) Pub. No.: US 2011/0308835 A1
(43) Pub. Date: Dec. 22, 2011

(54) SELF-COILING APPARATUS

(76) Inventor: Mark G. Piekny, Ferndale, MI (US)

(21) Appl. No.: 13/161,993

(22) Filed: Jun. 16, 2011

Related U.S. Application Data
(60) Provisional application No. 61/355,320, filed on Jun. 16, 2010.

(51) Int. Cl. H01B 7/06; F16L 55/00; B65H 55/04

(52) U.S. Cl. 174/69; 242/159; 138/103; 59/78

(57) ABSTRACT

A self coiling apparatus includes an article having a length and capable of being wound or coiled. At least one filament is formed of shape changing material and is wound about the article along its length. An actuation source is connected to the at least one filament and the at least one filament changes shape upon actuation. The at least one filament applies a force to the article and self-coils the article to a desired pattern.

### RELATED APPLICATION

This application claims priority of U. S. Provisional Patent Application Ser. No. 61/355,320 filed Jun. 16, 2010, which is incorporated herein by reference.

### FIELD OF THE INVENTION

The invention relates to a self coiling apparatus and more particularly to a self coiling cord.

### BACKGROUND OF THE INVENTION

Generally cords, ropes or other types of articles and particularly power cords and cables must be wound or bundled for storage when not in use. Various reels and coiling mechanisms exist in the art for storing and maintaining a cord. A person must often spend time and effort to wind a cord around such structures or alternatively to wind the cord by itself There is therefore a need in the art for an improved self coiling apparatus for such articles that that self coils an article when actuated.

### SUMMARY OF THE INVENTION

In one aspect, there is disclosed a self coiling apparatus that includes an article having a length and capable of being wound or coiled. At least one filament is formed of shape memory alloy and/or shape memory polymer and is wound about the article along its length. A power source is connected to the at least one filament. The at least one filament changes shape upon application of a voltage potential. The at least one filament applies a force to the article and self-coils the article to a desired pattern.

In another aspect, a self-coiling apparatus includes an article having a length and capable of being wound or coiled. Two filaments formed of shape memory alloy and/or shape memory polymer are wound helically about the article along its length. A power source is connected to the two filaments. The filaments change shape upon application of a voltage potential. The filaments apply an axial force to the article twisting the article to a desired shape.

In a further aspect, a self-coiling apparatus includes an article having a length and capable of being wound or coiled. A plurality of filaments formed of shape memory alloy and/or shape memory polymer are wound about the article along its length. A power source is connected to the plurality of filaments. The filaments change shape upon application of a voltage potential. The filaments apply a force to the article and self-coil the article to a desired pattern.

In another aspect, a self-coiling apparatus includes an article having a length and capable of being wound or coiled. At least one filament formed of shape memory polymer is wound about the article along its length. An actuation source is connected to the at least one filament. The filament changes shape upon actuation and self-coils the article to a desired pattern.

### BRIEF DESCRIPTION OF THE DRAWINGS

FIG. 1 is a side view of a self-coiling apparatus;

FIG. 2 is a top view of a self-coiling apparatus;

FIG. 3 is a cross-sectional view of one embodiment of a self-coiling apparatus;

FIG. 4 is a cross-sectional view of another embodiment of a self-coiling apparatus;

FIG. 5 is various side and top views of self-coiling apparatus;

FIG. 6 is a partial perspective view of one embodiment of a self-coiling apparatus;

FIG. 7 is a partial perspective view of one embodiment of a self-coiling apparatus;

FIG. 8 is a cross-sectional view of one embodiment of a self-coiling apparatus;

FIG. 9 is a partial perspective view of one embodiment of a self-coiling apparatus

FIG. 10 is a cross-sectional view of one embodiment of a self-coiling apparatus.

### DETAILED DESCRIPTION OF THE PREFERRED EMBODIMENTS

Referring to the various figures, there are shown embodiments of a self-coiling apparatus 10. The self-coiling apparatus 10 may include an article 15 having a length and capable of being wound or coiled. At least one filament 20 is formed of a shape changing material including a shape memory alloy and/or a shape memory polymer and is wound about the article 15 along its length. A power source 25 is connected to the at least one filament 20. The at least one filament 20 changes shape upon application of a voltage potential and applies a force to the article 15, self-coiling the article 15 to a desired pattern.

The self-coiling apparatus 10 may include various articles 15 that are capable of being coiled. For example, electrical cords, cords, ropes, hoses, chains, cables, or other elongated bodies capable of coiling may be utilized.

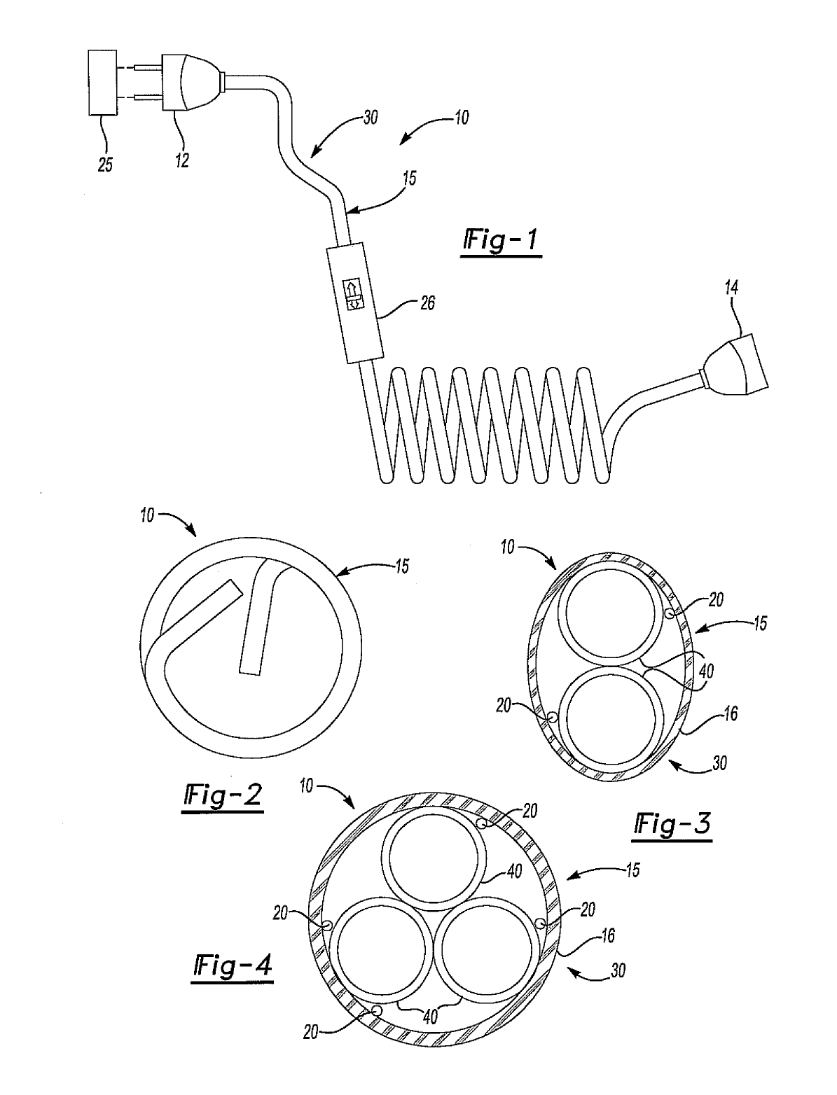

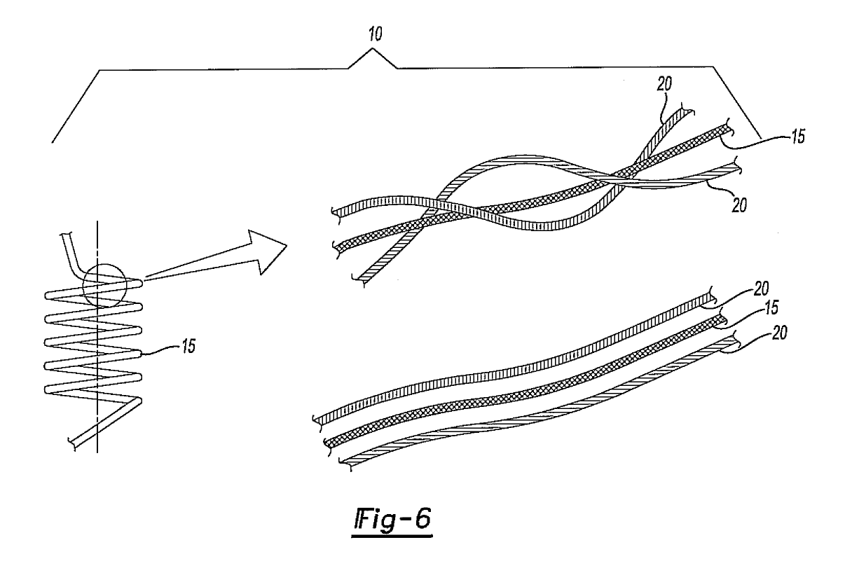

The at least one filament 20 may be wound about the article 15 in a predetermined orientation. Various numbers of filaments 20 may be wound about the article 15 based on the size of the article 15 or filament 20 and desired shape or coiling pattern. In one aspect, the at least one filament 20 may include a plurality of filaments 20 or may include two filaments 20 that are wound about the article 15 in a predetermined orientation. Referring to FIGS. 1, 3, 4 and 6, there is shown one embodiment of a self-coiling apparatus 10 for an electrical cord 30. As can be seen in the figures, various numbers of filaments 20 may be positioned or wound about the article 15. The embodiments shown in FIGS. 1, 3 and 4 include an electrical cord 30 having two and three conductors 40 and two and four filaments 20 surrounded by a sheath 16. The electrical cord 30 may include a plug portion 12 that is connected to the power supply. The plug portion 12 may or may not include the filaments 20 and may or may not change its shape. The electrical cord 30 may also include a receptacle portion 14 that will allow a device to be plugged into the electrical cord 30. Positioned between the plug portion 12 and the receptacle portion 14 is a coil section 18. The filaments 20 may be actuated by a switch 26 that may include a transformer or other regulating device. The filaments 20 may be wound about the article 15 or electrical cord 30 in various orientations. For example, the at least one filament 20 may be wound about the article 15 in a helical orientation as shown in FIG. 6. The embodiment displayed in FIG. 6 includes two filaments 20 that are wound in a helical pattern such that loops are positioned or wound on opposing sides of the article 15.

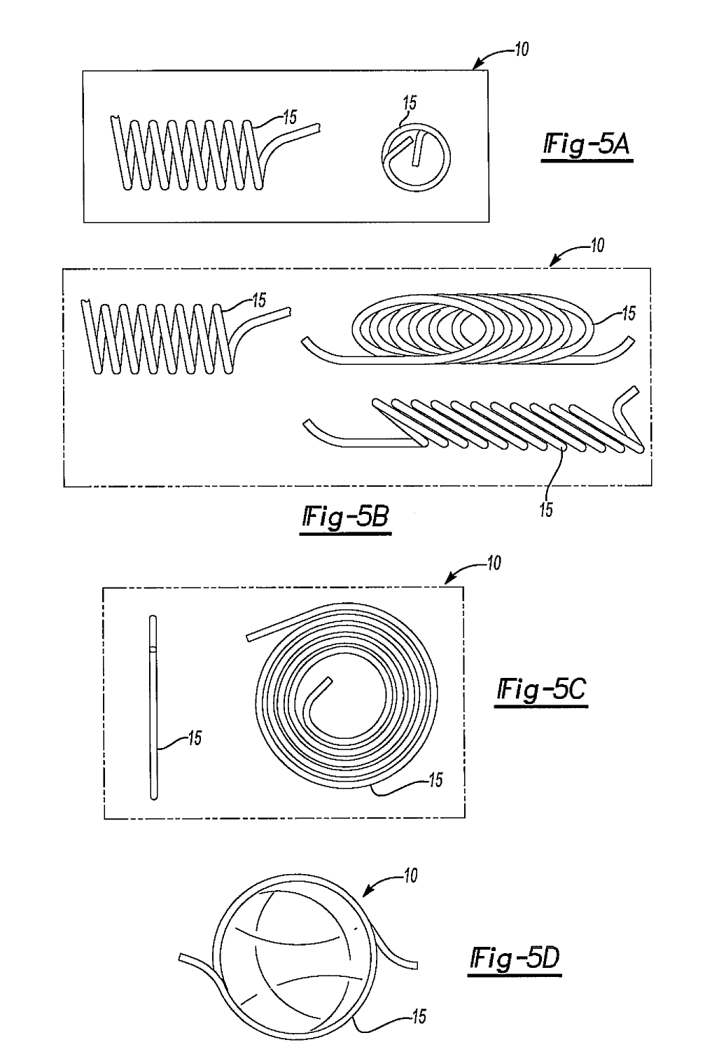

Various numbers of filaments 20 may be wound in various orientations to generate a specific orientation of the self-coiling apparatus 10. Referring to FIG. 5, there are shown various examples of coil patterns that may be utilized. For example, the at least one filament 20 may be wound about the article 15 in an orientation generating a self-coiled helix, a self-coiled flattened helix, a self-coiled flat spiral, or a self-coiled spherical spiral. These examples are a few of many orientations that may be utilized. It should be realized that the self-coiling apparatus 10 may include various filaments 20 wound in various patterns to generate a self-coiling apparatus 10 having shapes other than those displayed in FIG. 5. For example, various packaging requirements may require specific patterns or orientations that may be achieved utilizing filaments 20 wound in specific patterns to control a shape of a self-coiling apparatus 10.

As stated above, the at least one filament 20 is formed of a shape memory alloy and/or a shape memory polymer. Various shape memory alloys may be utilized including shape memory alloys that are formed of copper zinc aluminum nickel or copper aluminum nickel or nickel and titanium. In one aspect, the shape memory alloy may change phases from a martensite phase to an austenite phase upon a change in temperature. The shape memory alloy may have a one-way memory effect or a two-way memory effect, depending upon a desired application. The one-way memory effect alloy when in its cold state can be bent or stretched and will hold a desired shape until it is heated above a transition temperature. Upon heating, the shape will change to its original state, generating a desired coiled pattern, and will remain in the shape until a person or force is applied to it. In a two-way memory alloy, the material may have two different shapes, one at a lower temperature and one at a higher temperature. Various shape memory alloy filaments 20 may be produced to apply a desired axial force when wound about an article 15.

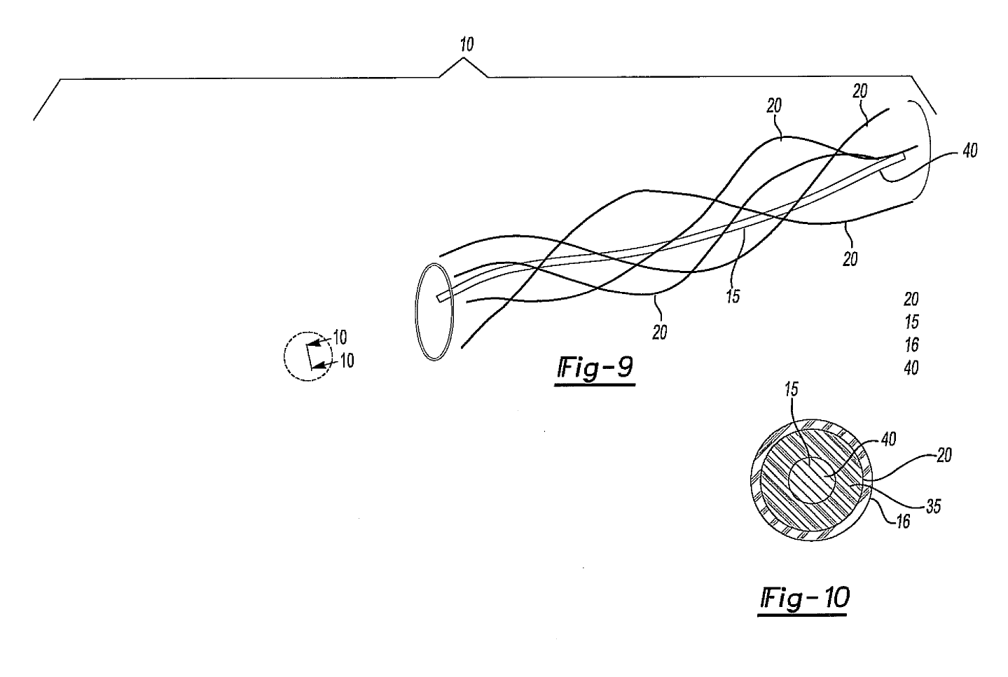

Additionally, a shape memory polymer layer 35 may be utilized, as shown in FIGS. 9 and 10. Shape memory polymers differ from shape memory alloys as the shape memory effect may be controlled by their glass transition or melting transition from a hard to a soft phase. Polymers exhibiting a shape memory effect have both a temporary form and a stored form. Shape memory polymers have a molecular network structure, which includes separate phases. Various shape memory polymers may be utilized including polyurethanes with ionic or mesogenic components made by a pre-polymer method. Other block copolymers include polyethylene terephthalate (PET) and polyethyleneoxide (PEO), block copolymers containing polystyrene and poly(1,4-butadiene), and an ABA triblock copolymer made from poly(2-methyl-2-oxazoline) and polytetrahydrofuran. Other polymers include linear, amorphous polynorbornene or organic-inorganic hybrid polymers of polynorbornene units that are partially substituted by polyhedral oligosilsesquioxane (POSS).

In addition to thermally activated shape memory polymers, other polymers may be activated by exposure to various wavelengths of light or by electric or magnetic fields. Examples of light induced polymers include polymers having a photo sensitive cross-linking that varies the cross-linking density within the material. Examples include materials having cinnamic acid and cinnamylidene acetic acid. Various electrical modified shape memory polymers may include carbon nanotubes, short carbon fibers, carbon black, and metallic Ni powder. The polymers may be produced by chemically surface-modifying multi-walled carbon nanotubes (MWNTs) in a mixed solvent of nitric acid and sulfuric acid. Various magnetic modified shape memory polymers may utilize surface-modified super-paramagnetic nanoparticles. An example includes oligo (e-capolactone)dimethacrylate/butyl acrylate composite with between 2 and 12% magnetite nanoparticles.

In one aspect, the filament 20 formed of the shape memory alloy and/or shape memory polymer may have a thickness of from 0.001-0.025 inches. The thickness of the filament 20 will have an effect on its ability to cool after being heated as well as have an effect on the size of the force applied to an article 15 when a voltage potential is applied. In one aspect, the at least one filament 20 may be wound about the article 15 in multiple passes such that a smaller gauge or size filament 20 may be utilized allowing it to cool more rapidly. Additionally, the filaments 20 may be nested with each other, again allowing multiple filaments 20 of a smaller gauge to be utilized, allowing a more rapid cooling in comparison to a larger gauge or thicker filament 20. In one aspect, the filaments 20 may be nested relative to each other to apply a twisting moment to the article 15 that facilitates self-coiling. The filament 20 wound about the article 15 may apply an axial force to the article 15 that twists the article 15 to a desired shape as described above.

Again referring to FIG. 6, the self-coiling apparatus 10 includes two filaments 20 wrapped helically about the article 15 in a nested pattern. The latent torsional or twisting tension generated between the filaments 20 may be utilized to augment a coiling impulse. The twisting tension is created as the filaments 20 on opposing sides of the article 15 apply opposing axial forces thus causing twisting that results in coiling.

As stated above, the self-coiling apparatus 10 may include a power source 25 connected to the at least one filament 20. Various transformers or other power devices may be utilized to generate a specific voltage requirement. Additionally, the voltage potential may be regulated from the power source to control a force applied to the article 15 that will affect the rate of coiling. In one aspect, the voltage potential range may be between 15 and 20 volts DC. It should be realized that various voltage requirements may be required for different length, size, and stiffness of articles 15. Various power source options include integrated AC/DC transformers that may pass a current directly to a device plugged into an outlet. Additionally, transformers may also be utilized with a battery or capacitor system in parallel or in sequence. Further, various batteries may be included as a power source. Additionally, various other sources of power including photovoltaic devices, fuel cells, or other such devices may be utilized as a power source and may be coupled to various circuitries to provide a desired voltage.

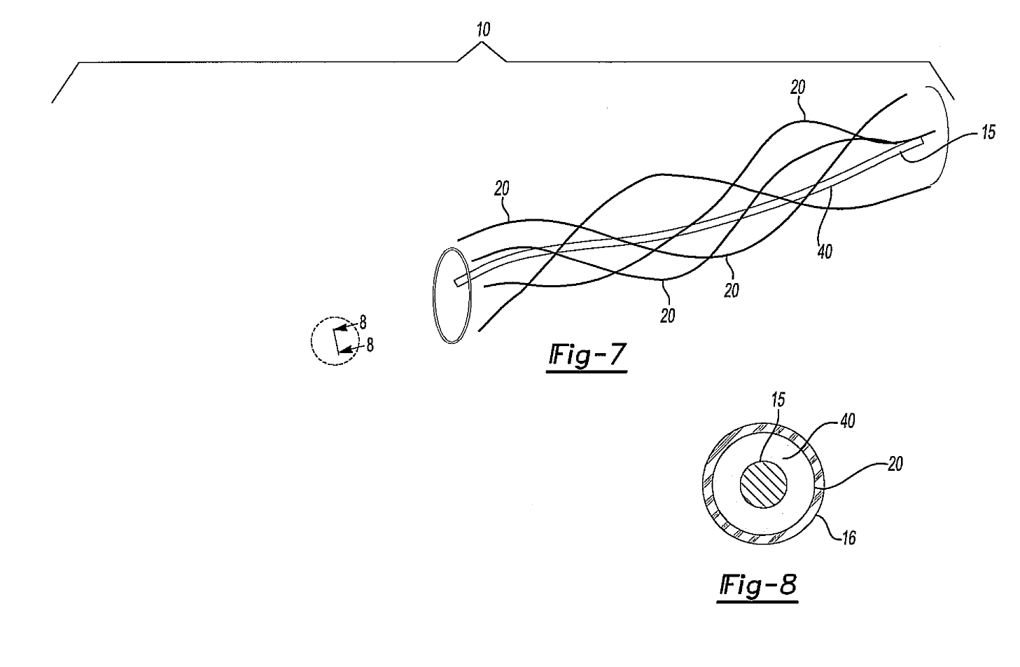

Referring to FIGS. 7-8 there is shown another embodiment of a self coiling apparatus 10. In the depicted embodiment, the at least one filament 20 includes a plurality of filaments 20. In one aspect the plurality of filaments 20 form or define a mesh about the article 15. The article 15 in the figures includes a carrier cord 40 that may be a power cord including conductors and a sheath. The filaments 20 may we positioned about the carrier cord 40 with another insulating sheath 16 positioned about the filaments 20. It should be realized that the conductors and filaments 20 may be positioned in a single sheath as previously described above.

Referring to FIGS. 9-10 there is shown another embodiment of the self coiling apparatus 10. In the depicted embodiment a shape memory polymer 35 is positioned about a carrier cord 40. The filaments 20 may be positioned about the shape memory polymer 35 or may be embedded in the polymer 35. As with the previously described embodiment in FIGS. 7 and 8 an insulating sheath 16 may be positioned about the filaments 20. It should be realized that the conductors and filaments 20 may be positioned in a single sheath as previously described above and that various numbers of filaments 20 may be utilized.

1. A self-coiling apparatus comprising:
an article having a length and capable of being wound or coiled;
at least one filament formed of shape changing material wound about the article along its length;
a power source connected to the at least one filament;
wherein the at least one filament changes shape upon application of a voltage potential, the at least one filament applying a force to the article and self-coiling the article to a desired pattern.

2. The self-coiling apparatus of claim 1 wherein the at least one filament is wound about the article in a predetermined orientation.

3. The self-coiling apparatus of claim 1 wherein the at least one filament includes a plurality of filaments.

4. The self-coiling apparatus 1 of claim wherein the at least one filament includes two filaments.

5. The self-coiling apparatus of claim 1 wherein regulation of a voltage potential of the power source controls a force applied to the article.

6. The self-coiling apparatus of claim 1 wherein the at least one filament is wound about the article in a helical orientation.

7. The self-coiling apparatus of claim 4 wherein the two filaments are wound about the article in a helical orientation.

8. The self-coiling apparatus of claim 1 wherein the at least one filament is wound about the article in an orientation generating a self-coiled helix.

9. The self-coiling apparatus of claim 1 wherein the at least one filament is wound about the article in an orientation generating a self-coiled flattened helix.

10. The self-coiling apparatus of claim 1 wherein the at least one filament is wound about the article in an orientation generating a self-coiled flat spiral.

11. The self-coiling apparatus of claim 1 wherein the at least one filament is wound about the article in an orientation generating a self-coiled spherical spiral.

12. The self-coiling apparatus of claim 1 wherein the article is an electrical cord.

13. The self-coiling apparatus of claim 12 wherein the electrical cord includes at least one conductor having the at least one filament wound about the conductor and a sheath covering the conductor and at least one filament.

14. The self-coiling apparatus of claim 1 wherein the article is selected from: a rope, hose, chain, cord, cable or other elongated body capable of coiling,

15. The self-coiling apparatus of claim 1 wherein the filament has a thickness of from 0.001-0.025 inches.

16. The self-coiling apparatus of claim 1 wherein the at least one filament is wound about the article in multiple passes.

17. The self-coiling apparatus of claim 3 wherein the plurality of filaments are nested with each other.

18. The self-coiling apparatus of claim 1 wherein the filaments are nested relative to each other to apply a twisting moment to the article facilitating self-coiling of the article.

19. The self-coiling apparatus of claim 1 wherein the filament applies an axial force to the article twisting the article to a desired shape.

20. The self-coiling apparatus of claim 1 wherein the at least one filament includes a plurality of filaments defining a mesh.

21. The self-coiling apparatus of claim 1 including a shape memory polymer positioned about the article.

22. The self-coiling apparatus of claim 1 wherein the at least one filament is formed of a shape memory polymer or a shape memory alloy or a combination thereof.

23. The self-coiling apparatus of claim 1 including a shape memory polymer positioned about the article with at least one filament positioned about the shape memory polymer.

24. A self-coiling apparatus comprising:
an article having a length and capable of being wound or coiled;
two filaments formed of shape memory alloy wound helically about the article along its length;
a power source connected to the at least one filament;
wherein the at least one filament changes shape upon application of a voltage potential, the at least one filament applying an axial force to the article twisting the article to a desired shape.

25. A self-coiling apparatus comprising:
an article having a length and capable of being wound or coiled;
at least one filament of shape memory polymer positioned about the article along its length;
an actuation source connected to the shape memory polymer filament;
wherein the at least one filament changes shape upon actuation, the at least one filament applying a force to the article and self-coiling the article to a desired pattern.
